(19) United States
(12) Patent Application Publication
(10) Pub. No.: US 2015/0373538 A1
(43) Pub. Date: Dec. 24, 2015

(54) Configuring Secure Wireless Networks

(71) Applicant: MivaLife Mobile Technology, Inc., George Town (KY)

(72) Inventors: Longgang Huang, San Jose, CA (US); Keqin Gu, Fremont, CA (US); Tsungyen Chen, Palo Alto, CA (US); Yan Qi, Fremont, CA (US)

(21) Appl. No.: 14/841,363

(22) Filed: Aug. 31, 2015

Related U.S. Application Data
(63) Continuation-in-part of application No. 13/843,547, filed on Mar. 15, 2013, now Pat. No. 9,125,049.

(51) Int. Cl. H04W 12/04; H04L 12/28; H04W 12/08

(52) U.S. Cl. CPC H04W 12/04; H04W 12/08; H04L 12/2807; H04L 2012/2841; H04W 84/12

(57) ABSTRACT

Methods, systems, and apparatus, including computer programs encoded on computer storage media, for configuring secure wireless networks. One of the methods includes receiving, at a security system management device, protocol and key information for establishing a connection as a client device to the wireless IP device, wherein the protocol and key information is received in response to a user transmitting an identifier for the IP device to a service provider system; establishing communication with the wireless IP device, wherein the wireless IP device is acting as an access point device; exchanging keys with the wireless IP device; rebooting the security system management device to become an access point for the secure wireless network; and establishing communication with the wireless IP device, wherein the wireless IP device has become a wireless client.

### PRIORITY CLAIM

This application is a continuation-in-part (CIP) application of U.S. Utility patent application Ser. No. 13/843,547, entitled “CONFIGURING SECURE WIRELESS NETWORKS,” filed on Mar. 15, 2013, which is incorporated by reference herein in its entirety.

### TECHNICAL FIELD

This specification relates to secure wireless networks.

### BACKGROUND

Wireless networks are typically advantageous over their wired counterparts, because they eliminate the need for stringing lengths of wire around a network site. This is especially useful in a home or enterprise security system in which multiple surveillance cameras and various sensors may be strategically placed around, both inside and outside, the home or office. Wireless networks further have the advantage that they cannot be easily circumvented by merely cutting the wired connections to network devices.

One conventional technique for adding a new device to a home network requires user input to provide configuration information. For example, a user can purchase a wireless device that is, typically, initially configured as an access point (AP) device. The user can use their mobile device to identify this AP device on their WiFi network and enter a password. The wireless device/AP device requests configuration information from the user of the mobile device, for example, a home router network service set identifier “SSID” and password. The user provides the requested information through the mobile device using an appropriate application. The wireless device/AP device is rebooted as a client device. An association is then made and the IP device is coupled to the home network.

In general, one innovative aspect of the subject matter described in this specification can be embodied in methods for adding a new wireless IP device to a secure wireless network that include the actions of receiving, at a security system management device, protocol and key information for establishing a connection as a client device to the wireless IP device, wherein the protocol and key information is received in response to a user transmitting an identifier for the IP device to a service provider system; establishing communication with the wireless IP device, wherein the wireless IP device is acting as an access point device; exchanging keys with the wireless IP device; rebooting the security system management device to become an access point for the secure wireless network; and establishing communication with the wireless IP device, wherein the wireless IP device has become a wireless client.

The foregoing and other embodiments can each optionally include one or more of the following features, alone or in combination. The IP device is an IP camera, IP based power plug, IP based thermostat, or other IP based security or automation device. The wireless IP device also receives key information from the service provider system. The IP device reboots following the key exchange, becoming a wireless client after the reboot. The identifier is a barcode scanned from the IP device. The identifier is a serial number for the IP device. Establishing communication with the wireless IP device as a client includes performing one or more of http request or receive functions. The http request function is used to request video data from the IP device.

### SUMMARY

In general, one innovative aspect of the subject matter described in this specification can be embodied in systems that include a security system management device, wherein the security system management device manages a particular secure wireless network; a wireless internet protocol (IP) device to be added to the secure wireless network; and a mobile device, wherein the IP device is activated using the mobile device including transmitting an identifier associated with the IP device to an external service provider system, wherein the security system management device receives protocol and key information for the IP device in response to the mobile device transmission, and wherein responsive to the received protocol the security system is configured as a WiFi client that seeks to communicate with the IP device, wherein the IP device is acting as an access point; wherein the IP device receives key information such that the IP device and security system manager exchange keys; and wherein after the key exchange, the security system manager reboots to become an access point for the network and the IP device reboots to become a wireless client for the network.

Particular embodiments of the subject matter described in this specification can be implemented so as to realize one or more of the following advantages. Wireless devices, e.g., internet protocol (IP) cameras, can be added to a secure wireless network without user configuration of the IP wireless device and without the need for preloaded SSID/Key pairs. Additionally, a security management device does not need to upload agent software to client wireless devices nor do the wireless devices need to be preprogramed with appropriate software. Instead, the security management device can use HTTP request and receive functions directed to the wireless device.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

One or more embodiments of the present invention are illustrated by way of example and not limitation in the figures of the accompanying drawings, in which like references indicate similar elements.

FIG. 1 is a diagram of an example security system.

FIG. 2 is a diagram illustrating an example process for integrating a device into a secure wireless network.

FIG. 3 is a flow diagram illustrating an example process for detecting and responding to an unauthorized access to a secure wireless network.

FIG. 4 is a diagram showing an example of computing system in which at least some operations related to configuring secure wireless networks can be implemented.

### DETAILED DESCRIPTION

References in this description to “an embodiment,” “one embodiment,” or the like, mean that the particular feature, function, structure or characteristic being described is included in at least one embodiment of the present invention. Occurrences of such phrases in this specification do not necessarily all refer to the same embodiment. On the other hand, the embodiments referred to also are not necessarily mutually exclusive.

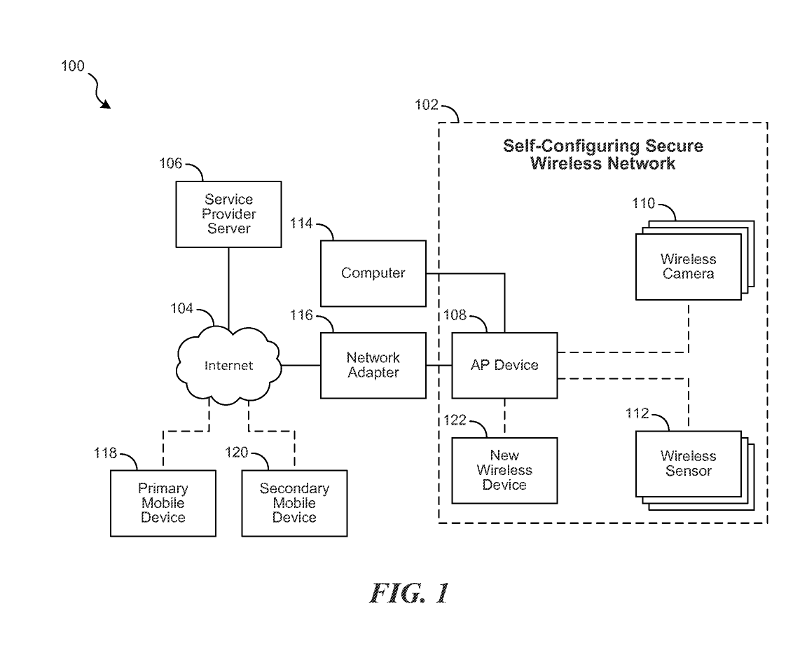

FIG. 1 is a diagram of an example security system 100. The security system 100 includes a secure wireless network 102, which is connected through the Internet 104 to a service provider system 106.

The secure wireless network 102 includes a security management device 108 and wireless enabled devices 110, 112. The security management device 108 can be an access point device. In some implementations, the security management device 108, optionally in conjunction with the service provider system 106, can determine and use appropriate keys to configure the wireless enabled devices 110, 112 thereby establishing a self-configured secure wireless network 102 with minimal or no user interaction.

In a typical home security system, several strategically positioned cameras 110 and sensors 112 may be included. In addition to sensors included for security purposes such as movement and displacement sensors, for example, detecting the opening of doors and windows, other sensors providing other useful information may be included such as doorbell sensors, smoke detector alarm sensors, temperature sensors, and/or environmental control sensors and/or controls.

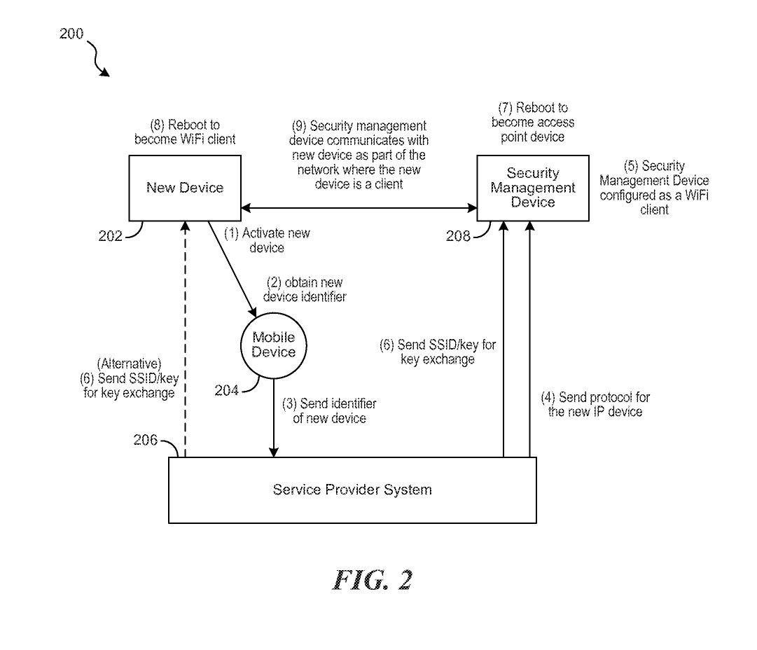

An additional wireless device 122 is also shown, which has been subsequently added to the secure wireless network 102 after the installation of the secure wireless network 102 in the home security system. Hence, it is referred to as being a “new” wireless device. Similar to the wireless enabled devices 110, 112, the new wireless device 122 can be added to the secure wireless network using an appropriate key. One example technique for adding a new wireless device to a secure wireless network is described below with respect to FIG. 2.

As shown in FIG. 1, the security management device 108 includes a router for the home security system. Therefore, all devices that are to be networked are communicatively coupled to the security management device 108. To this end, the security management device includes at least one of an Ethernet receptacle or Universal Serial Bus (USB) receptacle so that various devices such as a computer 114 may be wire-coupled to it, e.g., through an Ethernet connection. The security management device 108 is configured to be in “router” mode. As such it can be referred to as being a router security management device.

The security management device 108 is communicatively coupled, e.g., through an Ethernet connection, to a network adapter 116, e.g., a modem or directly to the Internet through an ISP. In some implementations, a broadband connection is used for high speed transmission of video data from the one or more wireless cameras and sensor data from the wireless sensors. The security management device 108 can include a Dynamic Host Configuration Protocol (DHCP) server which is configured to assign IP subaddresses to devices connecting through the security management device 108 to the Internet 104.

In some implementations, the security management device 108 includes a software agent residing in it that establishes communication with a remote service provider system 106 upon the security management device 108 being powered up and after it has been joined to the Internet 104 through the network adapter 116, which serves as an Internet gateway. The service provider system 106 interacts with the security management device 108 and authorized devices, e.g., primary and secondary mobile devices 118 and 120, to perform various functions and/or services.

The mobile devices 118 and 120 can include software agents or resident applications for such interaction with the service provider system 106. Devices that are attempting to interact with the service provider system 106 may confirm their authority to the service provider system 106, for example, by providing information that uniquely identifies the requesting device, e.g., an Internet Protocol (IP) address, a product serial number, or a cell phone number. Alternatively, they may provide a user name and password which are authorized to interact with the secure wireless network 102. To facilitate such authorization procedures, the service provider system 104 can store or have ready access to such authorization information for each secure wireless network of users who subscribe to the service. The mobile devices 118 and 120 can be used to receiving information from the security system, e.g., alarm information, as well as used to control functions of the security system.

FIG. 2 is a diagram 200 illustrating an example process for integrating a device into a secure wireless network. In particular, a new device 202 is being added to a self-configuring secure wireless network managed by security management device 208. For example, the self-configuring secure wireless network and associated devices can be similar to the self-configuring secure wireless network 102 and devices shown in FIG. 1.

The new device 202 can be, for example, a wireless IP device such as an IP camera. A user can add the IP camera as part of a home security system. In particular, the new device 202 can be configured as an access point device, for example, having a build-in router that is capable of allowing the new device 202 to connect to an external network including the Internet. An access point is a device that allows wireless devices to connect to a network using WiFi or related standards. Thus, other wireless devices can potentially connect to the access point as client devices. In particular, vendors of wireless IP devices typically configure the device to act as an access point.

The security management device 208 can be a wireless control unit that can be configured, for example, as a bridge, and access point, or a client. The security management device 208 is communicatively coupled to the Internet, e.g., by Ethernet to a home router, through which the security management device can communicate with service provider system 206. The security management device 208 also manages devices of the security system using the established secure wireless network. The devices can include other IP cameras as well as various security sensors. The home security system can be implemented, for example, as described above with respect to FIG. 1.

The new device 202 is activated (1). For example, the user can position the new device at a particular location and power it up. The user can also determine an identifier of the new device 202, for example, a serial number, bar code, QR code, or other identifier.

The identifier of the new device 202 is obtained (2) and entered into a mobile device 204. The mobile device 204 can be for example a mobile phone or tablet device of the user. The identifier of the new device 202 can be entered into the mobile device 204, for example, manually by the user or scanned into the mobile device, e.g., using a camera integrated into the mobile device, e.g., using barcode or QR code reading software.

The mobile device 204 transmits the identifier (3) of the new device 202 to a service provider system 206. The service provider system 206 uses the received identifier to look up information about the new device 202. For example, the identifier can be used to look up information in a registry or database associating device identifiers with corresponding device information. The registry or database can include information for wireless devices provided by various different vendors. For example, the device information can include protocol information associated with the device. This information can include a device type profile or one or more application programming interfaces (API) that can be used to communicate with the new device 202. In some examples, the information also includes an SSID/key pair that may be used to log into the new device 202, described further below.

The service provider system 206 sends (4) data to the security management device 208 identifying the protocol the new device 202 is operating under.

In response to receiving the protocol data, the security management device 208 behaves as a wireless client (5). As a client, the security management device can use the protocol information to identify and seek to connect with the new device 202 functioning as an access point device. In some embodiments where the protocol is assumed to be the same, steps 4 and 5 may be omitted.

Then, the service provider system 206 can pass (6) an SSID/key pair to the security management device 208 for use in a key exchange process between the security management device 208 and the new device 202 to generate a secure connection. In many situations, the service provider system 206 has knowledge of the SSID/key pair of the new device 202 because they are manufactured by the same vendor, or by vendors that have formed strategic alliance for performing the secure wireless network auto-configuration functionality introduced here. With the SSID/key pair, the security management device 208 can establish wireless communication with the new device 202. In certain implementations, some aforementioned steps (e.g., step 4) may be combined with this step 6. For example, the information passed from the service provider system 206 to the security management device 208 can also include (e.g., in addition to the SSID/key pair) a communication protocol. It is noted that different type of devices may have different suitable profiles (e.g., different passwords, SSIDs, and/or communication protocols), depending on the implementation. To enable to auto-configuration, the service provider system 206 is to send to the security management device 208 any suitable and relevant information that can enable the security management device 208 to successfully connect with the new device 202 as a client.

In addition or as an alternative to the aforementioned step 6, the service provider system 206 can select an SSID/key pair and pass (6) the selected SSID/key pair to both the security management device 208 and the new device 202 for use in a key exchange process between the security management device 208 and the new device 202 to generate a secure connection. In particular, the new device 202 can be in communication with one or more networks allowing communication with the service provider system 206, e.g., using the built in router and, for example, an Ethernet or other type of connection. In some implementations, the SSID/key pair is chosen specifically for the relationship between the new device 202 and the security management device 208. In some other implementations, the SSID/key pair is used for joining all devices to the secure wireless network. In such scenarios, the security management device 208 may already have the SSID/key pair. Various existing key exchange techniques can be used.

After the secure connection has been established between the service provider system 206 and the security management device 208, the security management device reboots (7) to become return to being an access point device. Additionally, the new device 202 reboots (8) to become a wireless client. In particular, the security management device 208 determines that the new device 202 has the new SSID and key/Password. Then both the security management device 208 and the new device 202 can reboot in which the new device 202 is wireless client and the security management device 208 is now the access point device.

The security management device 208 communicates (9) with the new device 202 as part of the secure wireless network where the new device 202 operates as a client device managed by the security management device 208. The security management device 208 can communicate with the new device 202 using http request and receive functions, e.g., a GET request. For example, in the case of an IP camera device, the security management device 208 can request data from the IP camera using, e.g., “http://IP/cgi/getdata” request wherein the response from the IP camera would be corresponding data such as video, image, or text data.

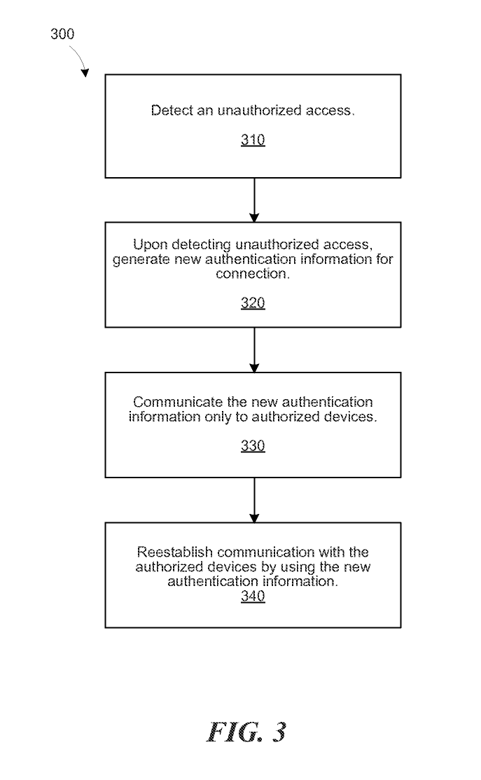

FIG. 3 is a flow diagram illustrating an example process 300 for detecting and responding to an unauthorized access to a secure wireless network. The process 300 can be performed by, for example, the security management device 208 in conjunction with the service provider system 206. To facilitate description, the process 300 is explained below with reference to FIGS. 1 through 3.

As previously mentioned, the security management device 208 typically operates in an access point mode for providing the secure wireless network 102. According to some embodiments, the security management device 208 can detect (310) an unauthorized access to the secure wireless network 102. In some embodiments, the security management device 208 performs unauthorized access detection when each time a new device is first connected to the security management device 208 (e.g., using the auto-configuration methods introduced above with respect to FIG. 2). In addition or as an alternative, the security management device 208 can perform unauthorized access detection periodically (e.g., per hour or per day).

Some implementations provide that the security management device 208 can keep an access control list (e.g., a white list). With the access control list, the security management device 208 can perform unauthorized access detection by identifying whether a connected device is listed in the access control list. The access control list contains all the devices that are authorized to connect to the security management device 208. For example, a unique identifier for each of all the authorized devices can be stored in the access control list. As a specific example, an unique identifier is the media access control (MAC) address of a device. If the connected device is not listed in the access control list, the security management device 208 determines that the connected device is unauthorized.

For security purposes, for those embodiments that implement the access control list, access to the access control list is preferably restricted. In some examples, the security management device 208 restricts the access to the access control list such that only the service provider system 206 can perform an update or an edit to the access control list. Consider the aforementioned process of adding the new device 202 as an example. The service provider system 206 can send an update to the access control list in the security management device 208 to include the new device 202. Depending on the implementation, the update can be an entirely new list that includes the new device 202, or an edit to include the new device 202 in the existing access control list. This update of access control list from the service provider system 206 can be a separate process, or can be combined with any suitable processes mentioned above (e.g., step 4 or step 6, FIG. 2).

More specifically, the update can be received in response to a transmission of an identifier for the new device 202 to the service provider system 206. For example, when the user first acquired the new device 202, using the above-mentioned auto-configuration technique, the user may use the mobile device 204 to obtain the new device's identifier (e.g., by capturing the QR code of the new device 202 with a camera on the mobile device 204). The identifier can include, for example, a one-dimensional code (e.g., barcode) or multi-dimensional code (e.g., QR code), a serial number, or any other suitable unique identifier, of the new device 202. The mobile device 204 may include a mobile software application (not illustrated for simplicity) that can communicate with the service provider system 206, such as the step 3 of FIG. 2. In some examples, the user can use the mobile software application to enter user credential so that the user can log onto his or her own or shared security control account. After receiving the request from the mobile device 204 to add the new device 202 into the secure wireless network 102, the service provider system 206 can perform an update to the access control list that is stored in the security management device 208 (e.g., in addition to those steps of auto-configuring in FIG. 2).

Additionally or alternatively, some examples of the security management device 208 can detect unauthorized access detection by initiating a secret handshake with a connected device (e.g., the new device 202). For example, the security management device 208 can use a unique command to query connected device for a status. If the connected device is an authorized device (e.g., manufactured by authorized vendors), then the connected device can understand the command and properly respond with correct information (e.g., in a correct format and using a correct protocol). The command can also be sent via a specific communication port. If the connected device fails to properly respond to the secret handshake, then the security management device 208 determines that the connected device is unauthorized.

In response to detecting the unauthorized access, the security management device 208 can take one or more actions to terminate and/or prevent the unauthorized access. According to some implementations, upon detecting an unauthorized access, the security management device 208 can automatically generate (320) new authentication information for connecting to the security management device 208. The new authentication information can include, for example, a new access key, a new service set identifier (SSID), a new communication protocol, or any combination thereof. In certain embodiments, the new authentication information is randomly generated based on a select set of rules. For example, the new authentication information can be a new random password that is of at least a certain length, and may include a concatenation of a certain number of capital letters, a certain number of small letters, and a certain number of special characters. For another example, the new authentication information can be a new SSID that includes a certain randomized number. In yet another example, the new authentication information can be a different security protocol, such as switching from WEP to WPA or WPA2.

After the new authentication information is generated, the security management device 208 communicates (330) the new authentication information only to those authorized devices listed in the access control list, so that only those authorized devices know how to connect to the security management device 208 with the new authentication information. The unauthorized device, even though it may have somehow gained access to the secure wireless network 102, would not be able to know the new authentication information. In some embodiments, the service provider system 206 may also query (e.g., via a secured channel) the security management device 208 to obtain the new authentication information. This can help those authorized devices that are not currently connected to the security management device 208 (thereby not receiving the new authentication information) to connect with the security management device 208 at a later time.

Thereafter, the security management device 208 reconfigures its communication circuitry for connection according to the new authentication information, and reestablishes (340) communication with those authorized devices by using the new authentication information. Optionally, the security management device 208 also blocks the device that is associated with the unauthorized access to prevent the device from connecting to the security management device 208, for example, by placing a MAC address of the unauthorized device into a MAC filter list.

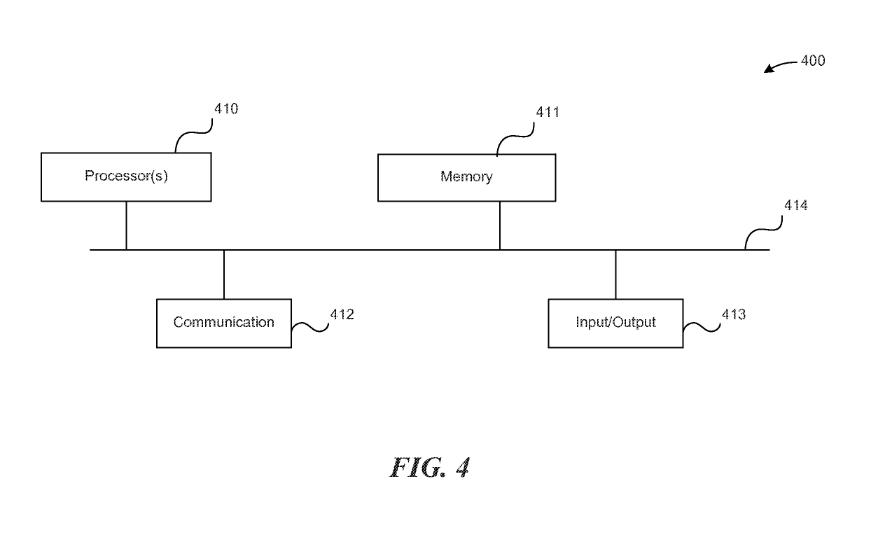

FIG. 4 is a high-level block diagram showing an example of a processing device 400 that can represent any of the devices described above, such as the new device 202, the mobile device 204, a server that operates the service provider system 206, or the security management device 208. As noted above, any of these systems may include two or more processing devices such as represented in FIG. 4, which may be coupled to each other via a network or multiple networks.

In the illustrated embodiment, the processing system 400 includes one or more processors 410, memory 411, a communication device 412, and one or more input/output (I/O) devices 413, all coupled to each other through an interconnect 414. The interconnect 414 may be or include one or more conductive traces, buses, point-to-point connections, controllers, adapters and/or other conventional connection devices. The processor(s) 410 may be or include, for example, one or more general-purpose programmable microprocessors, microcontrollers, application specific integrated circuits (ASICs), programmable gate arrays, or the like, or a combination of such devices. The processor(s) 410 control the overall operation of the processing device 400. Memory 411 may be or include one or more physical storage devices, which may be in the form of random access memory (RAM), read-only memory (ROM) (which may be erasable and programmable), flash memory, miniature hard disk drive, or other suitable type of storage device, or a combination of such devices. Memory 411 may store data and instructions that configure the processor(s) 410 to execute operations in accordance with the techniques described above. The communication device 412 may be or include, for example, an Ethernet adapter, cable modem, Wi-Fi adapter, cellular transceiver, Bluetooth transceiver, or the like, or a combination thereof. Depending on the specific nature and purpose of the processing device 400, the I/O devices 413 can include devices such as a display (which may be a touch screen display), audio speaker, keyboard, mouse or other pointing device, microphone, camera, etc.

Unless contrary to physical possibility, it is envisioned that (i) the methods/steps described above may be performed in any sequence and/or in any combination, and that (ii) the components of respective embodiments may be combined in any manner. In some implemented, one or more steps in the described methods, and/or one or more components in the described embodiments, may be omitted to fit a particular purpose.

The techniques introduced above can be implemented by programmable circuitry programmed/configured by software and/or firmware, or entirely by special-purpose circuitry, or by a combination of such forms. Such special-purpose circuitry (if any) can be in the form of, for example, one or more application-specific integrated circuits (ASICs), programmable logic devices (PLDs), field-programmable gate arrays (FPGAs), etc.

Software or firmware to implement the techniques introduced here may be stored on a machine-readable storage medium and may be executed by one or more general-purpose or special-purpose programmable microprocessors. A “machine-readable medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible medium can include recordable/non-recordable media (e.g., read-only memory (ROM), random access memory (RAM), magnetic disk storage media, optical storage media, flash memory devices, etc.).

Although the present disclosure has been described with reference to specific exemplary embodiments, it will be recognized that the disclosure is not limited to the embodiments described. Accordingly, the specification and drawings are to be regarded in an illustrative sense rather than a restrictive sense.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A wireless network device configured to:
upon receiving, from a remote service provider, authentication information for establishing a secured wireless network connection to a target wireless network device operating in an access point (AP) mode, switch the wireless network device into a client mode;
connect, based on the authentication information, to the target wireless network device as a client;
transmit, to the target wireless network device, an access key that allows for establishing a secured wireless network connection with the wireless network device;
cause the target wireless network device to switch into a client mode in which the target network device is to connect with the wireless network device as a client using said access key;
switch the wireless network device into an AP mode; and
establish a secured wireless network connection with the target wireless network device.

2. The wireless network device of claim 1, wherein the authentication information includes an access key that allows for establishing a secured wireless network connection with the target wireless network device.

3. The wireless network device of claim 1, wherein the authentication information includes a communication protocol that allows for establishing a secured wireless network connection with the target wireless network device.

4. The wireless network device of claim 1, wherein the authentication information includes information that enables the wireless network device to cause the target wireless network device to switch into a client mode.

5. The wireless network device of claim 1, wherein the authentication information is received in response to a transmission of an identifier for the target wireless network device to the remote service provider.

6. The wireless network device of claim 4, wherein the transmission is from a user mobile device.

7. The wireless network device of claim 1, wherein the identifier is at least one of: a one-dimensional or multi-dimensional code associated with the target wireless network device, a serial number of the target wireless network device, or a unique identifier of the target wireless network device

8. The wireless network device of claim 1, wherein the device is further configured to:
detect an unauthorized access to the wireless network device;
in response to detecting the unauthorized access, generate a new authentication information for connecting to the wireless network device.

9. The wireless network device of claim 8, wherein the device is further configured to:
communicate the new authentication information to an authorized device listed in an access control list; and
reestablish communication with the authorized device by using the new authentication information.

10. A wireless network device configured to:
detect an unauthorized access to the wireless network device;
in response to detecting the unauthorized access, generate new authentication information for connecting to the wireless network device;
communicate the new authentication information exclusively to one or more authorized devices listed in an access control list; and
reestablish communication with the one or more authorized devices by using the new authentication information.

11. The wireless network device of claim 10, wherein the unauthorized access is detected by the wireless network device performing at least:
identifying whether a connected device is listed in the access control list, the access control list containing all devices that are authorized to connect to the wireless network device; and
determining that the connected device is unauthorized in response to identifying that the connected device is not in the access control list.

12. The wireless network device of claim 11, wherein the access control list contains media access control (MAC) addresses of all devices that are authorized to connect to the wireless network device.

13. The wireless network device of claim 11, wherein said identify step is performed when the connected device is first connected to the wireless network device or is performed periodically or both.

14. The wireless network device of claim 10, wherein the unauthorized access is detected by the wireless network device performing at least:
initiating a secret handshake with a connected device; and
determining that the connected device is unauthorized in response to the connected device failing to properly respond to the secret handshake.

15. The wireless network device of claim 10, further configured to:
block a device that is associated with the unauthorized access to prevent the device from further connecting to the wireless network device.

16. The wireless network device of claim 10, further configured to:
restrict access to the access control list exclusively to a remote service provider.

17. The wireless network device of claim 10, further configured to:
receive, from a remote service provider, an update to the access control list to include a new device, wherein the update is received in response to a transmission of an identifier for the new device to the remote service provider.

18. The wireless network device of claim 17, wherein the identifier is at least one of: a one-dimensional or multi-dimensional code associated with the new device, a serial number of the new device, or a unique identifier of the new device.

19. The wireless network device of claim 10, wherein the new authentication information is randomly generated based on a select set of rules.

20. The wireless network device of claim 10, wherein the new authentication information includes at least one of: a new key, a new service set identifier (SSID), or a new communication protocol.
